(19) United States
(12) Patent Application Publication
(10) Pub. No.: US 2018/0050459 A1
(43) Pub. Date: Feb. 22, 2018

(54) PREPPING TOOL

(71) Applicant: ICI USA, LLC, SEATTLE, WA (US)

(72) Inventors: MATTHEW FRANK, SEATTLE, WA (US); RAQUEL RABAGO, SEATTLE, WA (US)

(21) Appl. No.: 15/243,420

(22) Filed: Aug. 22, 2016

(51) Int. Cl. B26B 25/00; B26B 29/06

(52) U.S. Cl. CPC B26B 25/007; B26B 29/063

(57) ABSTRACT

A prepping tool according to the claimed invention comprises an arm assembly having a first end and a second end, a handle base rotationally coupled to the first end of the arm assembly and a cutting device operably coupled to the second end of the arm assembly. The prepping tool is configured to cut an object in variable circumferences in a substantially circular fashion.

### CROSS-REFERENCES TO RELATED APPLICATIONS STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Crusts for pies, for example, are usually formed by rolling dough to a prescribed thickness, and then trimmed to a prescribed circumference. The circumference may be measured on a pastry mat having measurements or a pastry pan. Once the correct circumference is measured out, excess dough is cut away. However, use of a pastry mat requires the user to cut neatly around the circumference. Further, a pan, which may be used to both scribe and cut the dough, creates a circumference that is larger than the interior circumference of the pan. The top edge of the dough will burn, if not pressed below the pan causing the prescribed thickness to be altered. Alternatively, a round cutter of the correct circumference may be used. However, a user will need round cutters of various circumferences.

### SUMMARY OF THE INVENTION

An objective of this invention is to provide an apparatus that allows the user to easily measure and circumferentially cut dough, or other food or non-foodstuff having the same or similar qualities as dough.

### BRIEF DESCRIPTION OF THE DRAWINGS

Other features and advantages of the claimed invention will become apparent in the following detailed descriptions of the preferred embodiment with reference to the accompanying drawings, of which:

FIG. 1 shows a perspective view of a prepping tool according to one embodiment of the claimed invention;

FIG. 2 shows an exploded view of a prepping tool according to one embodiment of the claimed invention.

FIG. 3 shows a top view of a slide according to one embodiment of the claimed invention.

FIG. 4 shows a bottom view of an upper grip according to one embodiment of the claimed invention.

### DETAILED DESCRIPTION OF THE INVENTION

In the following detailed description, reference is made to the accompanying drawings, which form a part hereof. In the drawings, the use of similar or the same symbols in different drawings typically indicate similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

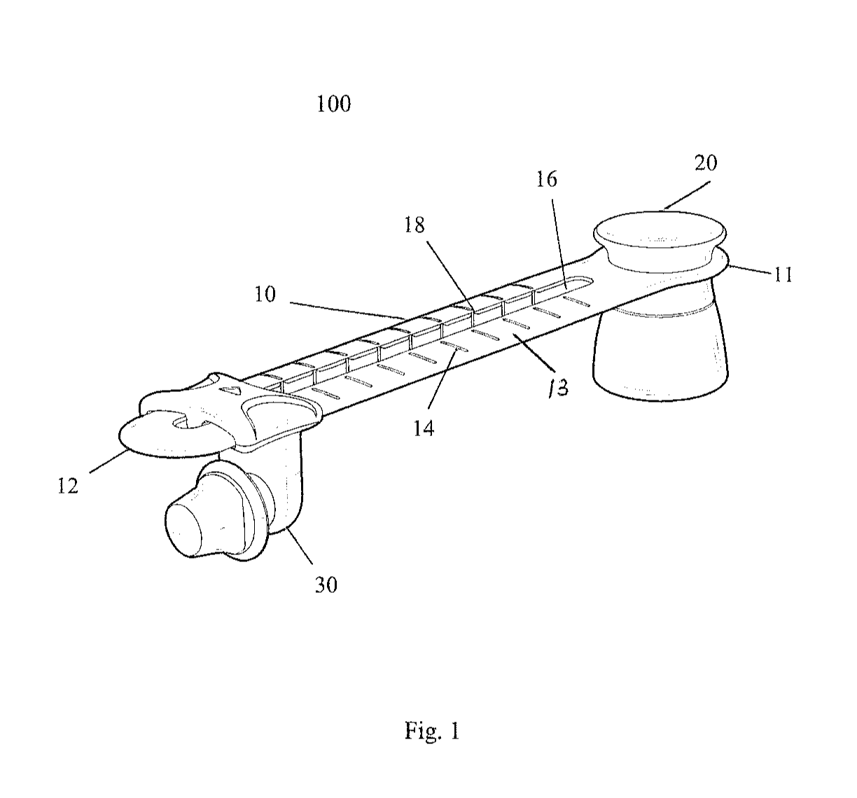

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Referring to FIG. 1, provided herein are embodiments of a prepping tool (100) that allows the user to easily measure and circumferentially cut dough, or other food or non-foodstuff having the same or similar qualities as dough.

In one embodiment, the prepping tool (100) is comprised of an arm assembly (10) having a first end (11) and second end (12) where, the first end (11) and the second end (12) lie on a longitudinal axis. The first end (11) of the arm assembly (10) is rotationally attached to a handle base (20). According to an embodiment, the handle base (20) allows the arm assembly to rotate 360°. The second end (12) of the arm assembly (10) is operably attached to a cutting device (30). According to an embodiment, the prepping tool (100) is used to make a circumferential cut. According to an embodiment, a user holds the handle base (20) at a defined location, on a flattened piece of dough, for instance, while rotating the cutting device (30) 360° around the handle base (20), in either a clockwise or counter-clockwise direction.

In one embodiment, the prepping tool (100) is comprised of an arm assembly (10) having a first end (11) and a second end (12). The arm assembly (10) is further comprised of an upper surface (13) and a bottom surface. The first end (11) of the arm assembly (10) is rotationally attached to a handle base (20). A cutting device (30) is movingly attached to the second end (12) of the arm assembly (10). The arm assembly (10) is periodically marked (14) on the upper surface (13) in the longitudinal direction. Here, the cutting device (30) may be moved to any of the periodic marks (14). As such, one may create a circumferential cut of a desired length by positioning the handle base (20), moving the cutting device to a desired periodic mark (14) and then rotating the cutting device around the handle base (20) of the prepping tool (100) in a clockwise or counter-clockwise direction.

In an embodiment, the prepping tool (100) is comprised of arm assembly (10) which defines at least one longitudinal slit (16) that is periodically marked (14) along the longitudinal direction of the upper surface (13) of the arm assembly (10). The marks (14) may be regularly positioned along the longitudinal direction to indicate a unit of length, such as, inches. According to one embodiment, the marks (14) may be indicated in centimeters. In still another embodiment, the marks (14) may be indicated in multiple units of length. According to one embodiment, the slit (16) may be indented regularly at its intersection with the upper surface (13) to comprise at least one notch (18) along the longitudinal direction of the arm assembly (10). Here, the number of notches (18) may at least correspond to the number of marks (14) specified on the upper surface (13) of the arm assembly (10). The cutting device (30) may thus be moved along the length of the arm assembly (10) to any of the periodic marks (14) and be held in position By the notches (18). The handle base (20) of the prepping tool (100) is positioned as previously described and the cutting device (30) is rotated 360° around the handle base (20) either clock-wise or counter-clockwise to create a circumferential cut of a desired length.

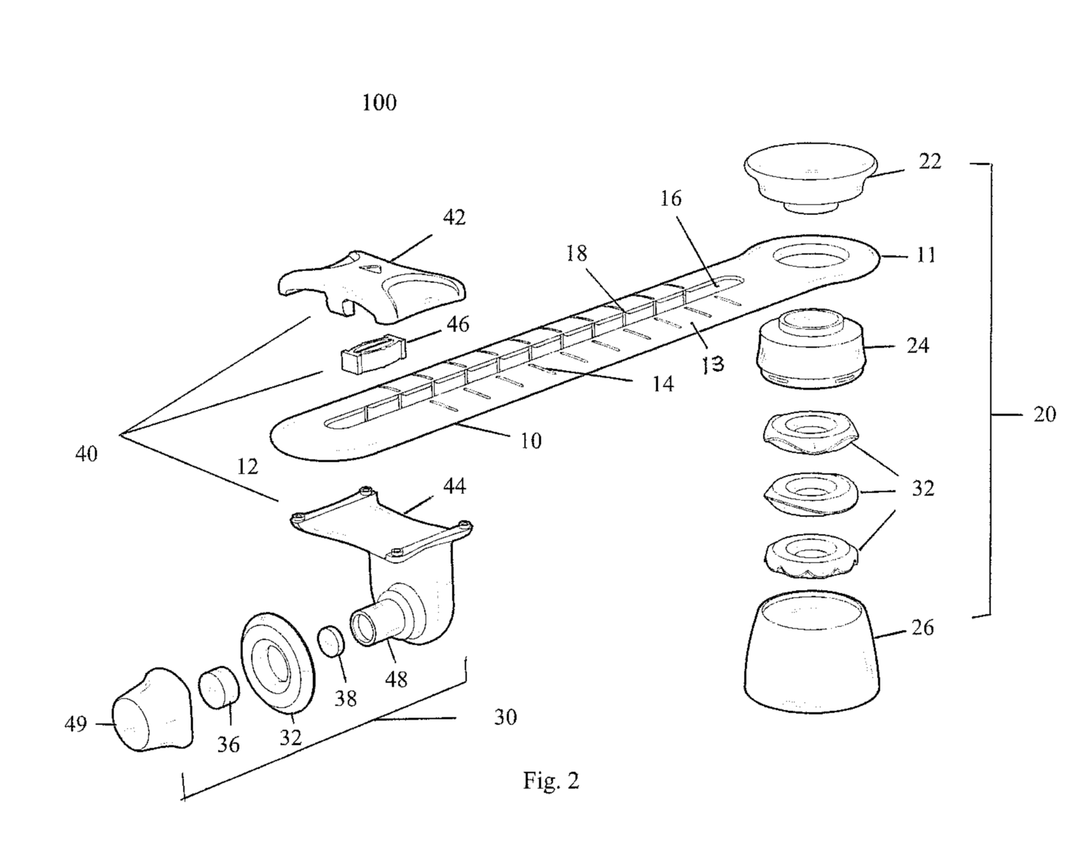

Referring to FIG. 2, provided is an exploded view of an embodiment of the prepping tool (100). In this embodiment the cutting device (30) is comprised of a control means (40) and a cutting means (32). Here, the cutting means (32) may be operably attached to a control means (40). The control means (40), in turn, may be movably attached to the arm assembly (10).

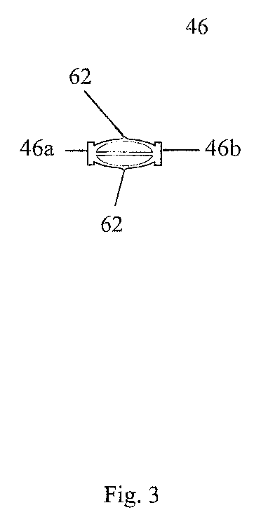

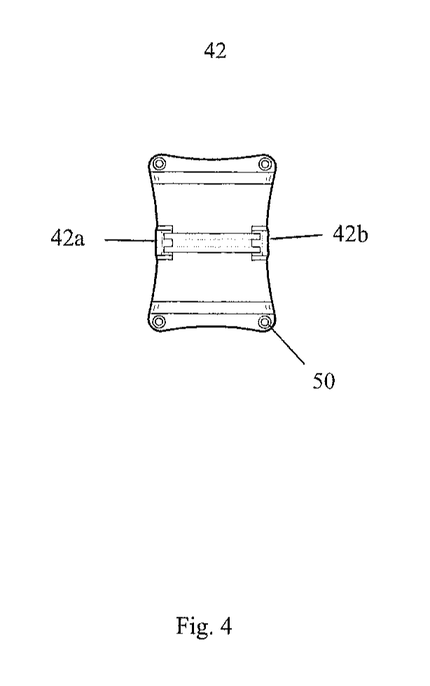

According to an embodiment, the control means (40) is further comprised of an upper grip (42), a lower support (44) and a slide (46). FIG. 3 shows an upper view of the slide (46) having a first end (46a) and the second end (46b) while FIG. 4, shows the bottom view of the upper grip (42) having tabs (42a, 42b) that may hold the slide (46) therein-between. More specifically, the tabs (42a and 42b) of the upper grip (42) shown in FIG. 4, press on the first end (46a) and the second ends (46b) of the slide (46) shown in FIG. 3, respectively, seating it firmly in position. At the same time, the upper grip (42) is attached to the lower support (44) so that assembled together, the control device (40) may glide along the length of the arm assembly (10) which is disposed therein-between. The upper grip (42) may be attached to the lower support using various fastening means (50) including but not limited to a bolt and nut, a rivet, a pin, a screw, and a snap button. According to one embodiment, the upper grip (42) is attached to the lower support (44) using at least one set screw. The slide (46) may be disposed between the upper grip (42) and the lower support (44) and fittingly inserted into the slit (16) of the arm assembly (10), where it may incrementally guide the control means (40) and thus the cutting means (32) operably connected to the cutting device (30) to move along the length of the arm assembly (10) to a desired position. According to an embodiment, the slide (46) may be comprised of protrusions (62) as shown in FIG. 3, disposed on one or both of its opposing outer surfaces. The protrusions (62) of the slide meet the inner surfaces of the slit (16) of the arm assembly (10) and may engage the notches (18) disposed along the inner surface of the slit (16) of the arm assembly as it moves along the slit, therefore holding the control means (40) and the cutting device (30) attached thereto in a desired position. According to an embodiment, the slide (46) may further comprise an arched structure, as shown in FIG. 3, which may enable it to ‘give’ in an elastic manner when it is depressed while being moved from one notched position to another and then ‘release’, returning to its original form and enabling it to lock into one or more notches once moved into a desired position within the length of the slit (16) of the arm assembly (10). In one embodiment, the slide (46) may be made of a substantially robust and smooth material such as, but not limited to, polypropylene.

The cutting device (30) is further comprised of a connector shaft (48) connected to the lower support (44) that removably accepts the cutting means (32) and a locking cap (49) which secures the cutting means (32) on to the lower support (44) and thus to the cutting device (30). In one embodiment, the connector shaft (48) is at least partially hollow and accepts a metal washer (38). The cutting means (32) slides onto the connector shaft (48) and is operably attached to the connector shaft when a magnet (36) mates with the metal washer (38) fastening the cutting means (32) into position. Here the magnet (36) is attached to the locking cap (49). It is established that other means of fastening the cutting means (32) to the cutting device (30) may be contemplated including but not limited to a screw, a pin, a rivet, a snap button or other means known in the art.

According to an embodiment, the handle base (20) is comprised of an upper part (22) a middle part (24) and a base part (26). The upper part (22) is connected to the lower part (24) and the arm assembly (10) is rotationally attached therein-between. In another embodiment, the lower part (24) of the handle base may be removably attached to a base part (26), where the lower part (24) and the base part (26) are comprised of a hollow portion to hold at least one cutting means (32) for storage.

According to an embodiment the cutting means (32) may be a cutting wheel. The cutting wheel may have a straight cutting edge. According to one embodiment, the cutting wheel may have non straight cutting edges such as grooved edges that can produce wavy cuts. The wells of the groove of the cutting wheel may be varied so that the resulting cut may produce wave patterns of various forms and sizes.

What is claimed is:

1. A prepping tool, comprising:
an arm assembly having a first end and a second end; where the first end and the second end are on a longitudinal axis;
a handle base rotationally coupled to the first end of the arm assembly; and
a cutting device operably coupled to the second end of the arm assembly;
wherein the tool is configured to cut an object in variable circumferences.

2. The prepping tool of claim 1, wherein
the arm assembly comprises regularly spaced marks along the longitudinal direction of the arm assembly

3. The prepping tool of claim 1, wherein the cutting device comprises;
a cutting means; and
a control means configured to adjust the position of the cutting device along the longitudinal direction of the arm assembly.

4. The prepping tool of claim 3, wherein the control means comprises;
an upper grip; and
a lower support, wherein the upper grip is disposed on the lower support and is attached to the lower support by a fastening means;
wherein the upper grip engages the arm assembly to guide the movement and positioning of the cutting device along the arm assembly.

5. The prepping tool of claim 4, wherein the lower support comprises;
a connector shaft configured to accept the cutting means;
a fastening means configured to attach the cutting means to the connector shaft; and
a locking cap configured to secure the cutting means to the cutting device.

6. The prepping tool of claim 3, wherein the cutting means comprises a cutting wheel.

7. The prepping tool of claim 6, wherein the cutting wheel comprises a curved cutting edge.

8. The prepping tool of claim 1, wherein the handle base is configured to store at least one cutting means.

9. A prepping tool, comprising:
an arm assembly having a first end, a second end and a slit disposed along a longitudinal direction therein-between;
a handle base rotationally coupled to the first end of the arm assembly;
a cutting device operably coupled to the second end of the arm assembly;
wherein the cutting device comprises a cutting means and a control means configured to adjust the position of the cutting device between the first and second ends of arm assembly along the slit;
wherein said prepping tool is configured to cut an object in variable circumferences

10. The prepping tool of claim 9, wherein
the arm assembly comprises;
regularly spaced marks on a surface of the arm assembly along the slit; and
a plurality of notches on at least one inner surface of the slit corresponding to the regularly spaced marks of the arm assembly.

11. The prepping tool of claim 9, wherein the control means further comprises;
an upper grip;
a lower support; and
a slide disposed therein-between;
wherein the upper grip is disposed on the lower support and engages the lower support by a fastening means; and
the upper grip further engages the slide by means of tabs disposed on two opposing sides of the upper grip;
wherein the slide guides the movement and positioning of the cutting device along the slit of the arm assembly.

12. The prepping tool of claim 11, wherein the slide comprises;
at least one protrusion on two opposing outer surfaces of the slide configured to engage at least one notch along the inner surface of the slit of the arm assembly.

13. The prepping tool of claim 11, wherein the lower support comprises;
a connector shaft configured to accept the cutting means;
a fastening means configured to attach the cutting means to the connector shaft; and
a locking cap configured to secure the cutting means to the lower support.

14. The prepping tool of claim 13, wherein the fastening means comprises a metal washer and a magnet.

15. The prepping tool of claim 9, wherein the handle base comprises;
an upper part;
a lower part; and
a base part, wherein the arm assembly is rotationally coupled between the upper part and the lower part of the handle base; and
the lower part is removably attached to the base part of the handle base.

16. The prepping tool of claim 15, wherein the lower part and the base part form a hollow portion configured to store at least one cutting means.

17. The prepping tool of claim 9, wherein the cutting means comprises a cutting wheel.

18. The prepping tool of claim 17, wherein the cutting wheel comprises a curved cutting edge.

19. A method for using a prepping tool to make a circumferential cut comprising the steps of:
placing a handle base on a flatten surface of a dough-like object, the handle base rotationally coupled to a first end of a longitudinal arm assembly;
adjusting position of a cutting device along the length of the arm assembly, the cutting device operationally coupled to a second end of a longitudinal arm assembly;
holding handle base down with one hand;
rotating the cutting device in a clock-wise or anti-clock-wise direction with the other hand.

20. The method of claim 19, wherein the cutting device is comprised of a control means and a cutting means.
